(19) United States
(12) Patent Application Publication
(10) Pub. No.: US 2009/0167561 A1
(43) Pub. Date: Jul. 2, 2009

(54) INTELLIGENT TRAFFIC LIGHT CONTROL SYSTEM

(75) Inventor: Zhilong Liang, Beijing (CN)

Correspondence Address: YING CHEN;Chen Yoshimura LLP, 255 S. GRAND AVE., # 215, LOS ANGELES, CA, 90012, US

(73) Assignee: AOCHENGTONGLI S&T DEVELOPMENT ( BEIJING ) CO., LTD, Beijing (CN)

(21) Appl. No.: 12/119,737

(22) Filed: May 13, 2008

(30) Foreign Application Priority Data
Dec. 26, 2007 (CN) 200710303846.2

(51) Int. Cl. G08G 1/095

(52) U.S. Cl. 340/907

(57) ABSTRACT

The invention relates to an intelligent traffic light control system comprising a microprocessor, a manual input device, an enforced switching device and an intelligent detecting device, wherein the microprocessor is used for controlling traffic lights, the manual input device is used for inputting control parameters of traffic light to the microprocessor, the enforced switching device is used for carrying a preferentially direct operation. The control system can automatically adjust the traffic light control parameters according to the changes of traffic flow in different directions, thereby increasing the traffic efficiency of intersection of roads and achieving a best control for traffic.

### BACKGROUND OF THE INVENTION

1. Field of the Invention

The invention relates to an intelligent traffic light control system that is mainly used to control traffic lights in an intersection of roads.

2. Description of the Related Art

The prior traffic light control system is arranged inside a cabinet positioned beside a road. The status of on/off of a traffic light is controlled through a microprocessor in the system to achieve a periodic switching. The system includes a manual input device and an enforced switching device. The control parameters such as switching period can be inputted to control traffic lights automatically through the manual input device. The traffic light can also be directly controlled through the enforced switching device. The shortcoming of prior technique is that the control parameters cannot be automatically adjusted by the system according to traffic flows in each direction. So, the system cannot be adapted to the traffic condition when the traffic condition is changed. It means that the traffic control in an intersection of roads will be not in a best state at all times.

### SUMMARY OF THE INVENTION

In order to overcome above shortcomings of the prior technique, the invention provides an intelligent traffic light control system. The control system can automatically adjust the traffic light control parameters according to the changes of traffic flow in different directions, thereby increasing the traffic efficiency of intersection of roads and achieving a best control for traffic.

The technical solution of the invention is that: an intelligent traffic light control system comprises a microprocessor, a manual input device, an enforced switching device and an intelligent detecting device, wherein the microprocessor is used for controlling traffic lights, the manual input device is used for inputting control parameters of traffic light to the microprocessor, the enforced switching device is used for carrying out a preferentially direct operation, the intelligent detecting device includes one or more panoramic cameras and an intelligent controller, wherein the one or more panoramic cameras are used for capturing real-time traffic flow images of each direction, the intelligent is used for receiving the real-time traffic flow images of each direction through a video capture board, identifying vehicles on each lane of each road, identifying status of driving and stopping of each vehicle, counting the length of queue of vehicles in each lane from the status of driving and stopping of each vehicle and sending an instruction for modifying traffic light control parameters to the microprocessor according to a preset program. The microprocessor modifies the traffic light control parameters after receiving the instruction.

Provided with an intelligent detecting device, this system can estimate the jamming condition of each road according to the length of queue of driving or stopping vehicles on each road, make a best control mode using a preset program by adjusting switching order and switching time of traffic lights to adapt to the actual traffic condition, thereby increasing traffic efficiency of an intersection of roads, reducing traffic jam of each road in each direction. That is beneficial to the normal traffic on roads, in particular to morning peak and evening peak of traffic, as the main flow directions of the mass and vehicles in morning peak and evening peak are different. Provided with one or more panoramic cameras, the intelligent detecting device can effectively capture images of traffic jam condition in each direction, thereby simplifying the device and ensuring the control effect at the same time.

### BRIEF DESCRIPTION OF THE DRAWING

FIG. 1 is a schematic view of an embodiment of the invention.

### DETAILED DESCRIPTION OF THE PREFERRED EMBODIMENTS

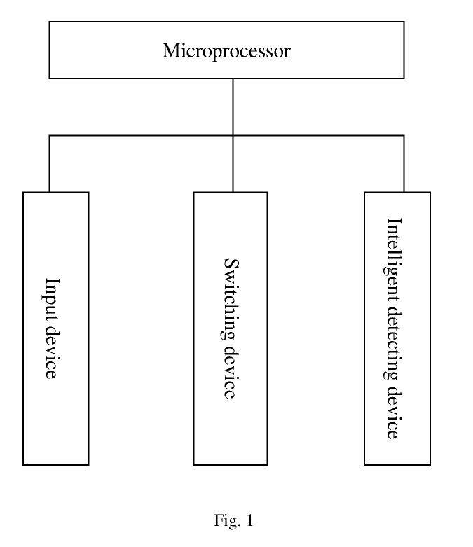

With reference to FIG. 1, the invention provides an intelligent traffic light control system comprises a microprocessor, a manual input device, an enforced switching device and an intelligent detecting device, wherein the microprocessor is used for controlling traffic lights, the manual input device is used for inputting control parameters of traffic light to the microprocessor, the enforced switching device is used for carrying out a preferentially direct operation, the intelligent detecting device includes one or more panoramic cameras and an intelligent controller, wherein the one or more panoramic cameras are used for capturing real-time traffic flow images of each direction, the intelligent controller is used for receiving the real-time traffic flow images of each direction through a video capture board, identifying vehicles on each lane of each road, identifying status of driving and stopping of each vehicle, counting the length of queue of vehicles in each lane from the status of driving and stopping of each vehicle and sending an instruction for modifying traffic light control parameters to the microprocessor according to a preset program. The microprocessor modifies the traffic light control parameters after receiving the instruction. The control system can automatically adjust the traffic light control parameter according to the traffic flow changes in different directions, thereby increasing the traffic efficiency of intersection of roads and achieving the best control for the traffic in intersection of roads.

The length of queue of vehicles in each lane is counted by the intelligent controller by following process:

(1) Identifying the statuses of driving or stopping of each vehicle on a lane of a road;

(2) Identifying the continuity of stopped vehicles;

(3) Counting the length of queue of stopped vehicles on the lane of the road, the distance from the first stopped vehicle to the last one is the length of queue;

(4) Identifying lanes and roads with the largest and smallest length of queue.

The traffic light control parameters are generated through a preset program or a preset mode following principles:

(1) When the road with the largest length of queue and the road with smallest length of queue are crossed with each other, increase the green light time of the road with the largest length of queue and decrease the green light time of the road with the smallest length of queue;

(2) When the roads with the largest length of queue and the decreased roads with smallest length of queue are on the two sides of same road, change the switching mode of traffic lights from making green lights on in dual directional for straight running to making green light on in single directional for straight running and left-turning;

(3) When the jamming situations of straight, left-turning and right-turning on the same road are obviously different, change green light time of the three directions.

The microprocessor, the manual input device, the enforced switching device and the intelligent detecting device are all installed inside a cabinet. The cabinet is provided with an anti-breaking detecting interface circuit and an alarm driving circuit which are used for receiving the detecting signal of illegally opening or breaking the cabinet door sent by an anti-breaking detecting device; the microprocessor generates an alarm driving signal and sends the alarm driving signal to the alarm driving circuit after receiving the detecting signal of illegally opening or breaking the cabinet door.

The alarm driving circuit is connected with an alarm (such as various audible and visual alarms) to control the alarm give a warning. The microprocessor also sends an instruction to the panoramic camera and controls the panoramic camera to picture the cabinet and the circumference of the cabinet after receiving the detecting signal of illegally opening or breaking the cabinet door so as to acquire the filed conditions during and after the illegal opening or damaging. The anti-breaking detecting device is usually arranged on the cabinet door of the cabinet, being one or two or more than two, thereby increasing the reliability.

When the quantity of the anti-breaking detecting devices is two or more than two, the cabinet anti-breaking detecting interface circuit is provided with the same quantity so as to be respectively connected with each anti-breaking detecting device, thereby avoiding the failing of report. The system alarms and pictures after receiving a detecting signal for illegal opening or damage that is sent by one of the detecting devices.

The cabinet includes a thermal insulation layer.

The cabinet also includes a front door or both with a front door and a back door. The thermal insulation layer is arranged on each lateral board and front door or on front door and back door. The other panels (such as the top board) of the cabinet can also be provided with a thermal insulation layer. The thermal insulation layer is generally made of rockwool materials and has the advantages of thermal insulation and fire proof.

The cabinet is internally provided with a heating device, a cooling device and/or a ventilating device that are used for adjusting the condition inside the cabinet, so that the electric device can always stay on a proper environment condition.

The ventilating device can take a convective fan, which is generally positioned on the internal top of the cabinet, thereby being beneficial for the wind flow inside the cabinet. The cabinet can be provided with a ventilator to change air with outside so as to adjust the temperature and humidity inside the cabinet.

The heating device can take an electric heating board that can be arranged at the lower part of the internal side of the lateral boards positioned at the two sides of the cabinet, thereby being beneficial for the thermal transmission inside the cabinet and also being beneficial for reducing the occupied area.

The heating board can take a quartz heating board with the advantages of small volume and small-occupied area. The heating device can be used for hearting the inside of the cabinet in winter when the temperature is over lower (For example, no more than minus 15 DEG C) so as to adjust the temperature inside the cabinet and ensure the stable operation of the system. The function is particularly suitable to the northern areas of our country, in particular to cold areas such as northeast and Inner Mongolia.

The cooling device can take a mini air conditioner or other styles of electric cooling boards 4 so as to reduce the occupied area and convenient for mounting. The electric cooling board can be arranged on the upper part of the internal side of the lateral boards positioned on the two sides of the cabinet, thereby being beneficial to the cool air transmission. The cooling device can be used to adjust the temperature inside the cabinet so as to ensure the stable operation of the system when the temperature is over high (For example, no less than 45 DEG C) summer.

The convective fan, the heating device and the cooling device can respectively be provided with an automatic control device. The processor of the automatic control device takes an electric device positioned inside the cabinet. The control of the convective fan, the heating device and the cooling device can be achieved by arranging corresponding software. The cabinet can be internally provided with a temperature sensor, and also can be internally provided with a humidity sensor according to particular demand. The sensors are connected with the automatic control devices of the convective fan, the heating device and the cooling device so as to send the temperature and the humidity inside the cabinet to the automatic control devices for corresponding control.

The traffic light of the invention refers to all the traffic signal lights, comprising red lights, green lights and yellow lights in color; and comprising straight walking lights, left turning lights, right turning lights, U-turning lights and non-arrowhead indication lights in indication direction.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. An intelligent traffic light control system, comprising:
a microprocessor for controlling traffic lights;
a manual input device for inputting control parameters of traffic light to the microprocessor;
an enforced switching device for carrying out a preferentially direct operation; and
an intelligent detecting device.

2. The system of claim 1, wherein the intelligent detecting device includes:
one or more panoramic cameras for capturing real-time traffic flow images of each direction, and
an intelligent controller for receiving the real-time traffic flow images of each direction through a video capture board, identifying vehicles in each lane of each road, identifying a status of driving and stopping of each vehicle, counting a length of a queue of stopped vehicles in each lane based on the status of driving and stopping of each vehicle and sending an instruction for modifying traffic light control parameters to the microprocessor.

3. The system of claim 2, further comprising a cabinet, wherein the microprocessor, the manual input device, the enforced switching device and the intelligent controller are arranged inside or on the cabinet.

4. The system of claim 3, wherein the cabinet includes:
an anti-breaking detecting interface circuit;
an alarm driving circuit; and
one or more anti-breaking detecting devices,
wherein the anti-breaking detecting interface circuit receives a detecting signal of illegally opening or breaking of a cabinet door sent by the anti-breaking detecting device and sends the signal to the microprocessor, and wherein the microprocessor generates an alarm driving signal and sends the alarm driving signal to the alarm driving circuit after receiving the detecting signal of illegally opening or breaking of the cabinet door.

5. The system of claim 4, wherein the alarm driving circuit is connected with an alarm.

6. The system of claim 5, wherein the microprocessor further sends an instruction to the one or more panoramic cameras and controls the one or more panoramic cameras to picture the cabinet and the circumference of the cabinet after receiving the detecting signal of illegally opening or breaking of the cabinet door.

7. The system of claim 3, wherein the cabinet further includes a thermal insulation layer arranged on each lateral board of the cabinet and a front door or on the front door and a back door of the cabinet.

8. The system of claim 3, further comprising a heating device, a cooling device and/or a ventilating device placed in the cabinet.

9. The system of claim 7, wherein the cabinet includes:
an anti-breaking detecting interface circuit;
an alarm driving circuit; and
one or more anti-breaking detecting devices,
wherein the anti-breaking detecting interface circuit receives a detecting signal of illegally opening or breaking of a cabinet door sent by the anti-breaking detecting device and sends the signal to the microprocessor, and wherein the microprocessor generates an alarm driving signal and sends the alarm driving signal to the alarm driving circuit after receiving the detecting signal of illegally opening or breaking of the cabinet door.

10. The system of claim 9, wherein the alarm driving circuit is connected with an alarm.

11. The system of claim 10, wherein the microprocessor further sends an instruction to the one or more panoramic cameras and controls the one or more panoramic cameras to picture the cabinet and the circumference of the cabinet after receiving the detecting signal of illegally opening or breaking of the cabinet door.

12. The system of claim 8, wherein the cabinet includes:
an anti-breaking detecting interface circuit;
an alarm driving circuit; and
one or more anti-breaking detecting devices,
wherein the anti-breaking detecting interface circuit receives a detecting signal of illegally opening or breaking of a cabinet door sent by the anti-breaking detecting device and sends the signal to the microprocessor, and wherein the microprocessor generates an alarm driving signal and sends the alarm driving signal to the alarm driving circuit after receiving the detecting signal of illegally opening or breaking of the cabinet door.

13. The system of claim 12, wherein the alarm driving circuit is connected with an alarm.

14. The system of claim 13, wherein the microprocessor further sends an instruction to the one or more panoramic cameras and controls the one or more panoramic cameras to picture the cabinet and the circumference of the cabinet after receiving the detecting signal of illegally opening or breaking of the cabinet door.
